(19) United States
(12) Patent Application Publication
(10) Pub. No.: US 2014/0166285 A1
(43) Pub. Date: Jun. 19, 2014

(54) NOVEL WEIGHTED ELASTOMER SYSTEMS FOR USE IN CEMENT, SPACER AND DRILLING FLUIDS

(71) Applicant: CLEARWATER INTERNATIONAL, LLC, Houston, TX (US)

(72) Inventors: Ashok Santra, The Woodlands, TX (US); Brian Seymour, Houston, TX (US); Ilia Kim Partch, Houston, TX (US)

(73) Assignee: CLEARWATER INTERNATIONAL, LLC, Houston, TX (US)

(21) Appl. No.: 14/102,658

(22) Filed: Dec. 11, 2013

Related U.S. Application Data
(60) Provisional application No. 61/737,271, filed on Dec. 14, 2012.

(51) Int. Cl. C09K 8/48; C09K 8/035; C09K 8/40; E21B 33/14

(52) U.S. Cl. CPC C09K 8/48; E21B 33/14; C09K 8/035; C09K 8/40
USPC 166/292; 175/65; 166/244.1; 524/8; 507/125; 507/231

(57) ABSTRACT

A drilling fluid, spacer fluid and cementing compositions for use in subterranean wells are disclosed along with methods for making using same, where the compositions include a particulate weighted elastomeric composition system including at least one higher density weighting agent and at least one elastomer, where the higher density weighting agents have a density of at least 5.0 g/cm³ and conventional weighting agents, to produce compositions having a desired high density, while retaining other fluid properties such as pumpability, gas tight sealing, low tendency to segregate, and reduced high temperature cement strength retrogression.

### RELATED APPLICATION

This application claims the benefit of and prior to U.S. Provisional Patent Application Ser. No. 61/737,271 filed 14 Dec. 2014 (Dec. 14, 2012).

### BACKGROUND OF THE INVENTION

1. Field of the Invention

Embodiments of this invention relate to novel weighted elastomer compositions for use in fluid compositions such as drilling fluids, drilling muds, kill fluids, and cement compositions for oil, gas, water, or geothermal wells or the like having a desired density.

More precisely, embodiments of this invention relate to novel weighted elastomer compositions or systems having a desired density for use in fluid compositions such as drilling fluids, drilling muds, kill fluids, and cementing compositions for oil, gas, water, injection, geothermal wells and/or other subterranean wells, while retaining other fluid properties such as pumpability, gas tight sealing, low tendency to segregate, improved resiliency, improved swellability, self-healing nature of cement matrices, and reduced high temperature cement strength retrogression, where the compositions include at least one high density weighting agent and at least one elastomer. Embodiments of this invention also relate to densified fluid compositions suitable for cementing zones, which are subjected to extreme static or dynamic stresses. Embodiments of this invention also relate to fluid compositions for use in the drilling and completion of oil and gas wells, which form a buffer between and prevent the mixing of various fluids used in the drilling and completion of oil and gas wells so called spacer fluids.

2. Description of the Related Art

Cement compositions may be used in a variety of subterranean applications such as cementing a pipe string (e.g., casing, liners, expandable tubulars, etc.) in place in a well bore. The process of cementing the pipe string in place is commonly referred to as “primary cementing.” Generally the primary cementing method involves pumping a cement composition into an annulus between the walls of the well bore and the exterior surface of the run in pipe string. The cement composition may set in the annular space forming an annular sheath of hardened, substantially impermeable cement, a cement sheath, that may support and position the pipe string in the well bore and may bond the exterior surface of the pipe string to the subterranean formation. Among other things, the cement sheath surrounding the pipe string functions to prevent the migration of fluids in the annulus, as well as protecting the pipe string from corrosion. Cement compositions also may be used in remedial cementing methods, for example, to seal cracks or holes in pipe strings or cement sheaths, to seal highly permeable formation zones or fractures, to place a cement plug, and the like.

After setting of cement in a well, particularly the setting of a cement sheath in an annulus of a well, the cement may fail due to downhole conditions such as shear stress, tensile stress, and compressional stress exerted on the set cement. Moreover, under certain conditions, the downhole conditions may cause the pipe to undergo both radial and longitudinal expansion. Such expansion generally may place stresses on the cement surrounding the casing causing the cement to crack and/or debond from the outside surface of the pipe and the surface of the formation. Furthermore, stressful conditions may also induce failure of set cement due to fluids being trapped in a cement sheath, which may undergo thermal expand resulting in the generation of high pressures within the sheath. Thermal expansion of trapped fluids may occur during production or injection of high temperature fluids through the well bore in process such as steam recovery or the production of hot formation fluids. Other conditions that may result in set cement failure include the forces generated by shifts in the subterranean formations surrounding the well bore or other over-burdened pressures.

Failure of cement within the well bore may result in cracking of the cement as well as a breakdown of the bonds between the cement and the pipe or between the cement sheath and the surrounding subterranean formations. Such failures can result in at least lost production, environmental pollution, hazardous rig operations, and/or hazardous production operations. A common result is the undesirable presence of pressure at the well head in the form of trapped gas between casing strings. Additionally, cement failures may be particularly problematic in multi-lateral wells, which include vertical or deviated (including horizontal) principal well bores having one or more ancillary, laterally extending well bores connected thereto.

High density particulate weighting materials and low density particulate elastomeric materials have previously been included in cement compositions to modify the mechanical properties of the set cement, including Young's Modulus, Poisson's Ratio, and the compressive and tensile strength. However, these materials may segregate during the placing and setting of the cement, leading to an undesirable density gradient in the set cement and lack to cement uniformity. As elastomeric materials generally have a specific gravity between about 0.8 and 1.5, they are difficult to mix homogeneously into a cement slurry or a drilling fluid, without floating or segregation. Even if they are mixed homogeneously, while stirring or while pumping downhole (or in dynamic conditions), they have a tendency to segregate while under static conditions before forming a hard set cement.

U.S. Pat. Application Pub. No. US 2012-0073813 A1 disclosed novel weighting system including ferrosilicon as the weighting agent. Ferrosilicon is a high density weighting agent, but being of such high density leads to problems associated the keeping the material from prematurely settling and/or separating from the fluid.

U.S. Pub. No. 20120202901 discloses cements with foamed elastomers. U.S. Pub. Nos. 20120172518, 20120172261 and 20110028594 disclose weighted elastomeric weighting system. U.S. Pub. No. 20110100626 discloses cementing compositions including unexpanded perlite. U.S. Pub. Nos. 20100218949 and 20080017376 disclose swellable elastomers used in downhole application. U.S. Pub. No. 20090308611 discloses cement composition including both high density particles and low density particles.

While many cementing compositions are known in the art, there is still a need in the art for new weighted elastomer compositions, where the density and settling characteristics may be tailored and the compositions including a high density material and an elastomeric material and where the specific gravity of the new particulate weighted elastomeric compositions are increased to at least 1.5; in certain embodiments, the specific gravity is at least 2.0.

### SUMMARY OF THE INVENTION

Embodiments of the present invention provide drilling fluid compositions including an effective amount of a particulate weighted elastomer system including at least one higher density agent and at least one elastomer, where the effective amount is sufficient to impart desired properties to the cement including density, particle settling, uniformity during pumping, placement, setting, compression, and expansion. The particulate weighed elastomer compositions are designed to produce stable drilling fluids with reduced or eliminated floating or settling problems and to improve resiliency and swellability properties of the drilling fluids and to improve resiliency, swellability, and self healing properties of cement during its life downhole.

Embodiments of the present invention provide cement compositions for cementing subsurface wells including an effective amount of a weighted elastomer system including at least one higher density agent and at least one elastomer, where the effective amount is sufficient to impart desired properties to the cement including density, particle settling, uniformity during pumping, placement, setting, compression, and expansion. The particulate weighted elastomer compositions are designed to produce stable cement slurries with reduced or eliminated floating or settling problems, to improve resiliency and swellability of cement slurries, set cements, and to improve self healing properties of cement during its life downhole.

Embodiments of the present invention provide spacer fluid compositions including an effective amount of a weighted elastomer system including at least one higher density agent and at least one elastomer, where the effective amount is sufficient to impart desired properties to the cement including density, particle settling, uniformity during pumping, placement, setting, compression, and expansion.

Embodiments of the present invention provide dry mix compositions for forming the aqueous spacer fluids by mixing with water, where the compositions include an effective amount of a particulate weighted elastomeric composition system including at least one higher weighting agent and at least one elastomer, where the effective amount is sufficient to impart desired properties to the cement including density, particle settling, uniformity during pumping, placement, setting, compression, and expansion.

Embodiments of the present invention provide master batch compositions for forming the compositions including at least one higher weighting agent and at least one elastomer. The master batches are formed by combining the weighting agents and the elastomers in dry or wet form (organic solvents or aqueous solutions) under conditions to form a homogeneous or substantially homogeneous (less than 15% variation of composition throughout the composition, sometimes less than 10% variation, other times less than 5% variation, and other times less then 1% variation) master batch compositions. If the master batches are wet, then the solid master batches are formed by solvent removal. The solid master batches may then be comminuting to form a particulate weighted elastomeric composition. The master batch may also include at least one coupling agent and/or at least one crosslinking agent.

Embodiments of this invention provide methods for drilling subterranean including circulating a drilling fluid, while drilling a borehole, where the drilling fluid includes an effective amount of a weighted elastomer system of a weighted elastomer system including at least one higher density agent and at least one elastomer, where the effective amount is sufficient to impart desired properties to the cement including density, particle settling, uniformity during pumping, placement, setting, compression, and expansion.

Embodiments of this invention provide methods for drilling subterranean including circulating a drilling fluid, while drilling a borehole, where the drilling fluid includes an effective amount of a weighted elastomer system of a weighted elastomer system including at least one higher density agent and at least one elastomer, where the effective amount is sufficient to impart desired properties to the cement including density, particle settling, uniformity during pumping, placement, setting, compression, and expansion.

Embodiments of this invention provide methods for cementing subterranean including pumping a cementing composition including an effective amount of a weighted elastomer composition of a weighted elastomer system including at least one higher density agent and at least one elastomer, where the effective amount is sufficient to impart desired properties to the cement including density, particle settling, uniformity during pumping, placement, setting, compression, and expansion.

Embodiments of this invention provide methods including displacing a first fluid such as a drilling fluid, with an incompatible second fluid such as a cement slurry, in a well. The spacer fluid functions to separate the first fluid from the second fluid and to remove the first fluid from the walls of the well, where the spacer fluid includes an effective amount of a weighted elastomer system of this invention. In drilling and completion operations, the purpose of the spacer fluid is to suspend and remove partially dehydrated/gelled drilling fluid and drill cuttings from the well bore and allow a second fluid such as completion brines, to be placed in the well bore.

Embodiments of this invention provide methods for making particulate weighted elastomer systems including at least one solid weighting agent and at least one solid elastomer, where the methods comprising combining the weighting agents and the elastomers to form a weighting material. The weighting material is then thoroughly mixed under heating or shearing conditions and then comminuted, ground, shredded or otherwise converted into the particulate weighted elastomeric composition systems of this invention. In certain embodiments, at least one crosslinking agent, at least one coupling agent, or a combination of at least one crosslinking agent and at least one coupling agent may be added to the weighting agents and the elastomers prior to or during mixing, where the crosslinking agents and/or coupling agents are designed to increase interactions between the weighting agents and the elastomers or to form bonds between the weighting agents and the elastomers in the weighted elastomer systems of this invention. The crosslinking agents are designed to crosslink the elastomers around the weighting agents, while the coupling agents are designed to react with the weighting agents and the elastomers in the particulate weighted elastomeric composition systems of this invention.

Embodiments of this invention provide methods for making particulate weighted elastomer systems including at least one weighting agent and at least one elastomer, where the methods comprise adding the weighting agents (dry or as an aqueous slurry) to an aqueous subsystem comprising the elastomers. The aqueous subsystem may be in the form of a solution, an emulsion, a suspension, a colloidal suspension, and/or a dispersion of the elastomers in water or an aqueous solution. The methods include mixing the resulting mixture until thoroughly mixed. The methods also include dewatering the mixture. Once dewatered, the resulting material may be comminuted to form the particulate weighted elastomer systems of this invention, which comprise the weighting agents and the elastomers. In certain embodiments, the aqueous system may also include at least one crosslinking agent, at least one coupling agent, or a combination of at least one crosslinking agent and at least one coupling agent, where the crosslinking agents and/or coupling agents are designed to increase interactions between the weighting agents and the elastomers or form bonds between the weighting agents and the elastomers in the weighted elastomer systems of this invention. The crosslinking agents are designed to crosslink the elastomers around the weighting agents, while the coupling agents are designed to react with the weighting agents and the elastomers in the particulate weighted elastomeric composition systems of this invention.

Embodiments of this invention also provide methods for making particulate weighted elastomer systems including at least one weighting agent and at least one elastomer, where the methods comprise adding the weighting agents (dry or as an organic slurry) to an organic subsystem comprising the elastomers. The organic subsystem may be in the form of a solution, a suspension, a colloidal suspension, and/or a dispersion of the elastomers in an organic solvent system. The methods include mixing the resulting mixture until thoroughly mixed. The methods also include removing the solvent from the mixture. Once solvent removal is complete, the resulting material may be comminuted to form the particulate weighted elastomer systems of this invention, which comprise the weighting agents and the elastomers. In certain embodiments, the organic system may also include at least one crosslinking agent, at least one coupling agent, or a combination of at least one crosslinking agent and at least one coupling agent, where the crosslinking agents and/or coupling agents are designed to increase interactions between the weighting agents and the elastomers or form bonds between the weighting agents and the elastomers in the weighted elastomer systems of this invention. The crosslinking agents are designed to crosslink the elastomers around the weighting agents, while the coupling agents are designed to react with the weighting agents and the elastomers in the particulate weighted elastomeric composition systems of this invention.

Embodiments of this invention also provide methods for making particulate weighted elastomer systems including at least one weighting agent and at least one elastomer, where the methods comprise adding the weighting agents to the elastomers or the elastomers to the weighting agent. The methods include mixing the weighting agents to the elastomers thoroughly to form a homogeneously mixed material. The resulting material may be comminuted to form the particulate weighted elastomer systems of this invention, which comprise the weighting agents and the elastomers. In certain embodiments, at least one crosslinking agent, at least one coupling agent, or a combination of at least one crosslinking agent and at least one coupling agent may be added to the weighting agents to the elastomers prior to or during mixing, where the crosslinking agents and/or coupling agents are designed to increase interactions between the weighting agents and the elastomers or to form bonds between the weighting agents and the elastomers in the particulate weighted elastomeric composition systems of this invention. The crosslinking agents are designed to crosslink the elastomers around the weighting agents, while the coupling agents are designed to react with the weighting agents and the elastomers in the weighted elastomer systems of this invention.

Embodiments of the present invention provide methods for preparing master batch compositions, where the master batch compositions include at least one higher weighting agent and at least one elastomer. The master batch may also include at least one coupling agent and/or at least one crosslinking agent. The methods for forming the master batches include combining the weighting agents and the elastomers in dry or wet form (organic solvents or aqueous solutions) under conditions to form a homogeneous or substantially homogeneous (less than 15% variation of composition throughout the composition, sometimes less than 10% variation, other times less than 5% variation, and other times less then 1% variation) master batch compositions. The conditions may be extrusion, internal mixing, mixing in stirred tank reactors, or mixing in any other method that produces as homogeneous or substantially homogeneous master batch composition. If the master batches are wet, then the methods also include removing the solvents from the wet master batches to form solid master batch compositions. The methods for removing solvent are well know in the art and any acceptable method may be used including heating, heating under vacuum, freeze drying, or other solvent removal techniques. The methods also include comminuting the solid master batches to form a particulate weighted elastomeric composition Additionally, the methods may include pre and post processing such as heating, curing, or other process to modify the nature of the master batch compositions prior to, during, and/or after comminuting.

### BRIEF DESCRIPTION OF DRAWINGS

The invention can be better understood with reference to the following detailed description together with the appended illustrative drawings in which like elements are numbered the same:

FIG. 1 depicts a photograph of a control cement composition CC after compression testing.

FIG. 2 depicts a photograph of a control cement composition EWC after compression testing

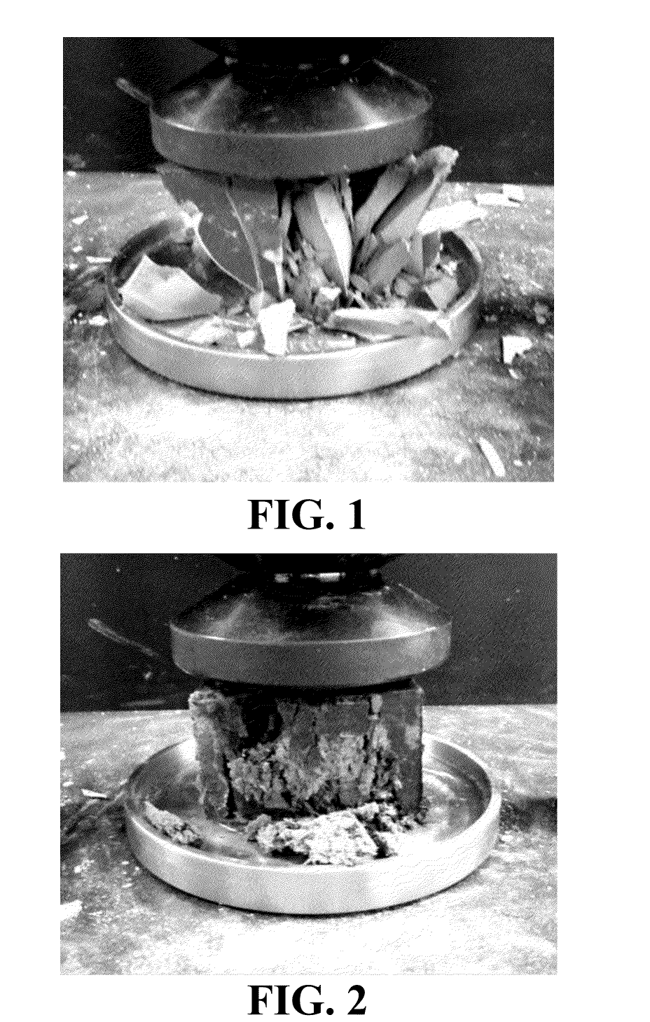

### DEFINITIONS OF TERM USED IN THE INVENTION

The following definitions are provided in order to aid those skilled in the art in understanding the detailed description of the present invention.

The term “weighted elastomer system” means a composition of this invention including at least one weighting agent and at least one elastomer, where the compositions increase the elastomer specific gravity to a specific gravity of at least 1.5; in certain embodiments, the specific gravity is at least 2.0. The weighting agents are selected to have a density of at least 5.0 g/cm³.

The term “surfactant” refers to a soluble, or partially soluble compound that reduces the surface tension of liquids, or reduces interfacial tension between two liquids, or a liquid and a solid by congregating and orienting itself at these interfaces.

The term “drilling fluids” refers to any fluid that is used during well drilling operations including oil and/or gas wells, geo-thermal wells, water wells or other similar wells.

The term “completion fluids” refers to any fluid that is used in oil and/or gas well completion operations.

The term “production fluids” refers to any fluid that is used in oil and/or gas well production operations.

The term “cementing composition” means a composition used to cement or complete a subterranean well.

The term “hydraulic cement” means a cementing composition that set up to a hard monolithic mass in the presence of water. Generally, any hydraulic cement may be used in the present invention. In certain embodiments, Portland cement may be used because of its low cost, availability, and general utility. In other embodiments, Portland cements of API Classes A, B, C, H, and/or G may be used in the invention. In other embodiments, other API Classes of cements, such as calcium aluminate and gypsum cement, may be used. In addition, mixtures or combinations of these cement components can be used. The characteristics of these cements are described in API Specification For Materials and Testing for Well Cements, API Spec 10 A, First Edition, January 1982, which is hereby incorporated by reference.

The term “spacer fluid or preflushing medium” means a fluid used to isolate fluids or to purge one fluid so that it can be replaced by a second fluid.

An over-balanced drilling fluid means a drilling fluid having a circulating hydrostatic density (pressure) that is greater than the formation density (pressure).

An under-balanced and/or managed pressure drilling fluid means a drilling fluid having a circulating hydrostatic density (pressure) lower or equal to a formation density (pressure). For example, if a known formation at 10,000 ft (True Vertical Depth—TVD) has a hydrostatic pressure of 5,000 psi or 9.6 lbm/gal, an under-balanced drilling fluid would have a hydrostatic pressure less than or equal to 9.6 lbm/gal. Most under-balanced and/or managed pressure drilling fluids include at least a density reduction additive. Other additives may be included such as corrosion inhibitors, pH modifiers and/or a shale inhibitors.

The term “foamable” means a composition that when mixed with a gas forms a stable foam.

The term “gpg” means gallons per thousand gallons.

The term “ppg” means pounds per thousand gallons.

The term “bwoc” means by weight of cement.

The term “gal/sk” means gallons per sack.

The term “lb/gal” means pounds per gallon.

### DETAILED DESCRIPTION OF THE INVENTION

The inventors have found that drilling fluid, spacer fluid, and cementing compositions for downhole drilling and cementing applications may be formulated using an effective amount of a particulate weighted elastomer compositions having a specific gravity of at least 1.5 in drilling fluids, spacer fluids, and cementing fluids. The inventors have found that particulate weighted elastomer compositions may be prepare by combining at least one weighting agent having a density of at least 5.0 g/cm³ and at least one elastomer are well suited for use in drilling fluids, spacer fluids, or cementing fluids. The inventors have found that the particulate weighed elastomer compositions are designed to produce stable drilling fluids with reduced or eliminated floating or settling problems and to improve resiliency and swellability properties of the drilling fluids and to improve resiliency, swellability, and self healing properties of cement during its life downhole. The inventors has also found that the particulate weighed elastomer compositions are designed to produce stable cement slurries with reduced or eliminated floating or settling problems and to improve resiliency and swellability of cement slurries and set cements, and to improve self healing properties of cement during its life downhole.

### Drilling Fluids

Generally, a drilling fluid is used during the drilling of a well. Drilling fluids may be designed for so-called over-balanced drilling (a hydrostatic pressure of the drilling fluid column is higher than the pore pressure of the formation), under-balanced drilling (a hydrostatic pressure of the drilling fluid column is lower than the pore pressure of the formation) or managed pressure drilling, where the hydrostatic pressure of the drilling fluid is managed depending on the nature of the material through which drilling is occurring. Each type of drilling uses different types of drilling fluids. In the drilling fluids of this invention, the drilling fluids include an effective amount of a weighted elastomer compositions of this invention.

### Compositional Ranges

In certain embodiments, the fluids (drilling, spacing, cementing etc.) include an effective amount of the weighted elastomer system of this invention having a specific gravity of at least 1.5.

### SUITABLE REAGENTS FOR USE IN THE INVENTION

### Weighting Compositions Components

Weighting Agents

Higher Density Weighting Agents

Suitable higher density weighting agents for use in the composition of this invention including, without limitation, any water insoluble agent having a density greater than 5 g/cm³. Exemplary examples of higher density weighting agents include, without limitation, ferrosilicon, pyrite, ferromanganese, ferromanganese silicon, other metal silicon alloys, barium titanate, strontium titanate, other metal titanates, or mixtures of combinations thereof.

Secondary Weighting Agents

Secondary weighting agents that may be used with the higher density weighing agents include, without limitation, iron, steel, barite, hematite, other iron ores, tungsten, tin, manganese, manganese tetraoxide, calcium carbonate, illmenite, sand or mixtures and combinations thereof.

Particle Sizes of Weighting Agents

The higher density weighting agents and other weighting agents may be in the form of nano-particles, micro-particles, powders (mixture of particles sizes), shot, granular, or mixtures and combinations thereof. The powders include particles having an average particle diameter size between about 10 nm and about 1 mm. In other embodiments, the powder comprises particles having an average particle diameter size between about 100 nm and about 1000 μm. In other embodiments, the powder comprises particles having an average particle diameter size between about 500 nm and about 500 μm.

Elastomers

Suitable elastomers for use in the present invention include, without limitation, epichlorohydrin ethylene oxide copolymers, chlorinated polyethylenes, sulphonated polyethylenes, poly 2,2,1-bicyclo heptenes, alkylstyrenes, crosslinked substituted vinyl acrylate copolymers, ethylene-propylene rubbers, ethylene-propylene-diene terpolymer rubbers, ethylene vinyl acetate copolymers, butyl rubbers, brominated butyl rubbers, chlorinated butyl rubbers, neoprene rubbers, styrene butadiene rubbers, natural rubbers, ethylene acrylate rubbers, fluorosilicone rubbers, silicone rubbers, thermoplastic elastomers, diene rubbers including polybutadienes, polyisoprene, polyhexadiene, polyolefins including polyethylene, polybutenes, poly-1-hexene, isoprene butadiene rubbers, isoprene butadiene block copolymers, polystyrene butadiene random copolymers, styrene butadiene block copolymers, styrene butadiene styrene block copolymers, hydrogenated styrene butadiene rubbers, styrene isoprene copolymers, styrene butadiene isoprene copolymers, styrene isoprene block copolymers, styrene isoprene butadiene block copolymers, hydrogenated styrene isoprene copolymers, hydrogenated styrene butadiene isoprene copolymers, hydrogenated styrene isoprene block copolymers, hydrogenated styrene isoprene butadiene block copolymers, hydrogenated isoprene butadiene block copolymers, and mixtures or combinations thereof.

Water Swellable Elastomers

Suitable water swellable elastomers for use in the present invention include, without limitation, polymethacrylates, polyacrylamides, non-soluble acrylic polymers, starch-polyacrylate acid graft copolymers and salts thereof, polyethylene oxide polymers, carboxymethyl cellulose type polymers, poly(acrylic acid) and salts thereof, poly(acrylic-co-acrylamide) and salts thereof, graft-poly(ethylene oxide) of poly(acrylic acid) and salts thereof, poly(2-hydroxyethyl methacrylate), poly(2-hydroxypropyl methacrylate), polyvinyl alcohol cyclic acid anhydride graft copolymer, isobutylene maleic anhydride, vinylacetate-acrylate copolymer, starch-polyacrylonitrile graft copolymer, an acrylate butadiene rubber, a polyacrylate rubber, an isoprene rubber, a choloroprene rubber, and mixtures or combinations thereof.

Oil Swellable Elastomers

Suitable oil swellable elastomers for use in the present invention include, without limitation, natural rubbers, polyurethane rubbers, nitrile rubbers, hydrogenated nitrile rubbers, acrylate butadiene rubbers, polyacrylate rubbers, butyl rubbers, brominated butyl rubbers, chlorinated butyl rubbers, chlorinated polyethylene rubbers, isoprene rubbers, choloroprene rubbers, neoprene rubbers, butadiene rubbers, styrene butadiene rubbers, styrene isoprene rubbers, styrene butadiene isoprene rubbers, isoprene butadiene rubbers, sulphonated polyethylenes, ethylene acrylate rubbers, epichlorohydrin ethylene oxide copolymers, ethylene-propylene-copolymers (peroxide cross-linked), ethylene-propylene-copolymers (sulphur cross-linked), ethylene-propylene-diene terpolymer rubbers, ethylene vinyl acetate copolymers, fluoro rubbers, a fluoro silicone rubbers, a silicone rubbers, poly 2,2,1-bicyclo heptenes (polynorborneanes), polyalkylstyrenes, crosslinked substituted vinyl acrylate copolymers, and mixtures or combinations thereof.

Crosslinking Agents

Suitable crosslinking agents for use in this invention include, without limitation, radiation cure systems, peroxide cure systems, sulfur based cure systems, other systems capable of curing elastomers, and mixtures or combinations thereof.

Coupling Agents

Suitable coupling agents for use in this invention include, without limitation, any compound capable of reacting both with the weighting agents and the elastomers used in the weighting compositions of this invention. Exemplary examples of such coupling agents include, without limitation, coupling agents of the formulas (R²R³R⁴Si—)ₙ—R¹ or (R²R³R⁴Si—R⁵—)ₙ—R¹, where R², R³, and R⁴ are hydrolyzable groups, R⁵ is a linking group and R¹ is a reactive group, coupling agents disclosed in U.S. Pat. No. 7,723,409, coupling agents of the general formula (RO)₃SiCH₂CH₂CH₂—X, where RO is a hydrolyzable group, such as methoxy, ethoxy, or acetoxy, and X is halogen atom available from Evonik Industries, Mobile, Ala., coupling agents of the general formula (RO)₃SiCH₂CH₂CH₂X, where RO is a hydrolyzable group, such as methoxy, ethoxy, or acetoxy, and X is an organofunctional group, such as amino, methacryloxy, epoxy, etc., available form Dow Corning and mixtures or combinations thereof.

### Cements Components

Hydraulic cement is a component that may be included in embodiments of the cement compositions of the present invention. Any of a variety of hydraulic cements suitable for use in subterranean cementing operations may be used in accordance with embodiments of the present invention. Suitable examples include hydraulic cements that comprise calcium, aluminum, silicon, oxygen and/or sulfur, which set and harden by reaction with water. Such hydraulic cements, include, but are not limited to, Portland cements, pozzolana cements, gypsum cements, high-alumina-content cements, slag cements, silica cements, sorel cement, geopolymeric cement, and combinations thereof. In certain embodiments, the hydraulic cement may comprise a Portland cement. The Portland cements that may be suited for use in embodiments of the present invention are classified as Class A, C, G, and H cements according to American Petroleum Institute, API Specification for Materials and Testing for Well Cements, API Specification 10, Fifth Ed., Jul. 1, 1990. In addition, in some embodiments, hydraulic cements suitable for use in the present invention may include cements classified as ASTM Type I, II, or III.

Weighted Elastomer System Components

The cement also includes a weighted elastomer system of this invention, where the weighted elastomer systems including at least one higher density weighing agent and at least one elastomer. In certain embodiments, the particulate weighted elastomeric composition systems of this invention may also include a crosslinking system and/or a coupling system.

Component Ranges

The weighted elastomer system of this invention may include a weighting agent to elastomer weight ratio between about 9:1 to about 1:9. In certain embodiments, the ratio is between about 8:1 to about 1:8. In other embodiments, the ratio is between about 7:1 to about 1:7. In other embodiments, the ratio is between about 6:1 to about 1:6. In other embodiments, the ratio is between about 5:1 to about 1:5. In other embodiments, the ratio is between about 4:1 to about 1:4. In other embodiments, the ratio is between about 3:1 to about 1:3. In other embodiments, the ratio is between about 2:1 to about 1:2. In other embodiments, the ratio is between about 1:1.

Specific Gravity

The weighted elastomer systems of this invention have specific gravities between about 1.5 and about 4.0. In certain embodiments, the weighted elastomer systems have specific gravities of at least 1.5. In other embodiments, the weighted elastomer systems have specific gravities of at least 1.75. In other embodiments, the weighted elastomer systems have specific gravities of at least 2.0. In other embodiments, the weighted elastomer systems have specific gravities between about 1.75 and about 4.0. In other embodiments, the weighted elastomer system have specific gravities between about 2.0 to about 4.0.

Cement Slurry

The weighted elastomer systems of this invention are present in the cement slurry in an amount between about 0.5% by weight of cement (bwoc) and about 50% bwoc. In certain embodiments, the weighted elastomer systems are present in the cement slurry in an amount between about 1.0% by weight of cement (bwoc) and about 50% bwoc. In other embodiments, the weighted elastomer systems are present in the cement slurry in an amount between about 5.0% by weight of cement (bwoc) and about 50% bwoc. In certain embodiments, the weighted elastomer systems are present in the cement slurry in an amount between about 10.0% by weight of cement (bwoc) and about 50% bwoc.

### Drilling Fluid Components

Suitable Drilling Fluid Components for Aqueous Based Fluids

Suitable aqueous base fluids for use in this invention includes, without limitation, seawater, freshwater, saline water or such makeup system containing up to about 30% crude oil.

Suitable Drilling Fluid Components for Oil Based Fluids

Suitable oil based fluids for use in this invention includes, without limitation, synthetic hydrocarbon fluids, petroleum based hydrocarbon fluids, natural hydrocarbon (non-aqueous) fluids or other similar hydrocarbons or mixtures or combinations thereof. The hydrocarbon fluids for use in the present invention have viscosities ranging from about 5×10′ to about 600×10⁻⁶m²/s (5 to about 600 centistokes). Exemplary examples of such hydrocarbon fluids include, without limitation, polyalphaolefins, polybutenes, polyolesters, vegetable oils, animal oils, other essential oil, diesel having a low or high sulfur content, kerosene, jet-fuel, internal olefins (IO) having between about 12 and 20 carbon atoms, linear alpha olefins having between about 14 and 20 carbon atoms, polyalpha olefins having between about 12 and about 20 carbon atoms, isomerized alpha olefins (IAO) having between about 12 and about 20 carbon atoms, VM&P Naptha, Limpar, Linear paraffins, detergent alkylates and Parafins having between 13 and about 16 carbon atoms, and mixtures or combinations thereof.

Suitable polyalphaolefins (PAOs) include, without limitation, polyethylenes, polypropylenes, polybutenes, polypentenes, polyhexenes, polyheptenes, higher PAOs, copolymers thereof, and mixtures thereof. Exemplary examples of PAOs include PAOs sold by Mobil Chemical Company as SHF fluids and PAOs sold formerly by Ethyl Corporation under the name ETHYLFLO and currently by Albemarle Corporation under the trade name Durasyn. Such fluids include those specified as ETYHLFLO 162, 164, 166, 168, 170, 174, and 180. Well suited PAOs for use in this invention include blends of about 56% of ETHYLFLO now Durasyn 174 and about 44% of ETHYLFLO now Durasyn 168.

Exemplary examples of polybutenes include, without limitation, those sold by Amoco Chemical Company and Exxon Chemical Company under the trade names INDOPOL and PARAPOL, respectively. Well suited polybutenes for use in this invention include Amoco's INDOPOL 100.

Exemplary examples of polyolester include, without limitation, neopentyl glycols, trimethylolpropanes, pentaerythriols, dipentaerythritols, and diesters such as dioctylsebacate (DOS), diactylazelate (DOZ), and dioctyladipate.

Exemplary examples of petroleum based fluids include, without limitation, white mineral oils, paraffinic oils, and medium-viscosity-index (MVI) naphthenic oils having viscosities ranging from about 5×10′ to about 600×10⁻⁶ m²/s (5 to about 600 centistokes) at 40° C. Exemplary examples of white mineral oils include those sold by Witco Corporation, Arco Chemical Company, PSI, and Penreco. Exemplary examples of paraffinic oils include solvent neutral oils available from Exxon Chemical Company, high-viscosity-index (HVI) neutral oils available from Shell Chemical Company, and solvent treated neutral oils available from Arco Chemical Company. Exemplary examples of MVI naphthenic oils include solvent extracted coastal pale oils available from Exxon Chemical Company, MVI extracted/acid treated oils available from Shell Chemical Company, and naphthenic oils sold under the names HydroCal and Calsol by Calumet.

Exemplary examples of vegetable oils include, without limitation, castor oils, corn oil, olive oil, sunflower oil, sesame oil, peanut oil, other vegetable oils, modified vegetable oils such as cross linked castor oils and the like, and mixtures thereof. Exemplary examples of animal oils include, without limitation, tallow, mink oil, lard, other animal oils, and mixtures thereof. Other essential oils will work as well. Of course, mixtures of all the above identified oils can be used as well.

Suitable foaming agents for use in this invention include, without limitation, any foaming agent suitable for foaming hydrocarbon based drilling fluids. Exemplary examples of foaming agents include, without limitation, silicone foaming agents such as tetra(trimethylsiloxy)silane, fluorinated oligomeric or polymeric foams such as fluorinated methacrylic copolymer, or other similar foaming agents capable of producing a foam in a hydrocarbon or oil-based drilling fluid or mixtures or combinations thereof. Exemplary examples of such foaming agents include, without limitation, DC-1250 available from Dow Corning, Zonyl FSG available from DuPont, APFS-16 available from Applied Polymer, A4851 available from Baker Petrolite, Superfoam available from Oilfield Solutions, Paratene HFA available from Woodrising, DVF-880 available from Parasol Chemicals INC., JBR200, JBR300, JBR400, and JBR500 available from Jeneil Biosurfactant Company, Paratene HFA, Paratene HFB, Paratene MFA, Paratene MFB available from Woodrising Resources Ltd. or mixture or combinations.

Suitable polymers for use in this invention include, without limitation, any polymer soluble in the oil based fluid. Exemplary polymers include, without limitation, a polymer comprising units of one or more (one, two, three, four, five, . . . , as many as desired) polymerizable mono-olefins or di-olefins. Exemplary examples includes, without limitation, polyethylene, polypropylene, polybutylene, or other poly-alpha-olefins, polystyrene or other polyaromatic olefins, polybutadiene, polyisoprene, or other poly-diolefins, or copolymers (a polymer including two or more mono-olefins or di-olefins) or copolymers including minor amount of other co-polymerizable monomers such as acrylates (acrylic acid, methyl acrylate, ethyl acrylate, etc.), methacrylates (methacrylic acid, methyl methacrylate, ethyl methacrylate, etc), vinylacetate, maleic anhydride, succinic anhydride, or the like, provided of course that the resulting polymer is soluble in the hydrocarbon base fluid.

Suitable gelling agents for use in this invention include, without limitation, any gelling agent. Exemplary gelling agents include, without limitation, phosphate esters, ethylene-acrylic acid copolymer, ethylene-methacrylic acid copolymers, ethylene-vinyl acetate copolymers, ethylene-maleic anhydride copolymers, butadiene-methacrylic acid copolymers, ethylene-methacrylic acid copolymers, styrene-butadiene-acrylic acid copolymers, styrene-butadiene-methacrylic acid copolymers, or other copolymer including monomers having acid moieties or mixtures or combinations thereof. Exemplary examples phosphate ester gelling agents include, without limitation, WEC HGA 37, WEC HGA 70, WEC HGA 71, WEC HGA 72, WEC HGA 702 or mixtures or combinations thereof, available from Weatherford International. Other suitable gelling agents include, without limitation, WEEL-VIS II available from Weatherford, Ken-Gel available from Imco or the like.

Suitable cross-linking agent for use in this invention include, without limitation, any suitable cross-linking agent for use with the gelling agents. Exemplary cross-linking agents include, without limitation, di- and tri-valent metal salts such as calcium salts, magnesium salts, barium salts, copperous salts, cupric salts, ferric salts, aluminum salts, or mixtures or combinations thereof. Exemplary examples of cross-linking agents for use with phosphate esters include, without limitation, WEC HGA 44, WEC HGA 48, WEC HGA 55se, WEC HGA 55s, WEC HGA 61, WEC HGA 65 or mixtures or combinations thereof available from Weatherford International.

Suitable defoaming agents for use in this invention include, without limitation, any defoaming agent capable of reducing the foam height of the foamed drilling fluid systems of this invention. Exemplary examples of defoaming agents are low molecular weight alcohols with isopropanol or isopropyl alcohol (IPA) being preferred.

Gases

Suitable gases for foaming the foamable, ionically coupled gel composition include, without limitation, nitrogen, carbon dioxide, or any other gas suitable for use in formation fracturing, or mixtures or combinations thereof.

Corrosion Inhibitors

Suitable corrosion inhibitor for use in this invention include, without limitation: quaternary ammonium salts e.g., chloride, bromides, iodides, dimethylsulfates, diethylsulfates, nitrites, bicarbonates, carbonates, hydroxides, alkoxides, or the like, or mixtures or combinations thereof; salts of nitrogen bases; or mixtures or combinations thereof. Exemplary quaternary ammonium salts include, without limitation, quaternary ammonium salts from an amine and a quaternarization agent, e.g., alkylchlorides, alkylbromide, alkyl iodides, alkyl sulfates such as dimethyl sulfate, diethyl sulfate, etc., dihalogenated alkanes such as dichloroethane, dichloropropane, dichloroethyl ether, epichlorohydrin adducts of alcohols, ethoxylates, or the like; or mixtures or combinations thereof and an amine agent, e.g., alkylpyridines, especially, highly alkylated alkylpyridines, alkyl quinolines, C₆ to C₂₄ synthetic tertiary amines, amines derived from natural products such as coconuts, or the like, dialkylsubstituted methyl amines, amines derived from the reaction of fatty acids or oils and polyamines, amidoimidazolines of DETA and fatty acids, imidazolines of ethylenediamine, imidazolines of diaminocyclohexane, imidazolines of aminoethylethylenediamine, pyrimidine of propane diamine and alkylated propene diamine, oxyalkylated mono and polyamines sufficient to convert all labile hydrogen atoms in the amines to oxygen containing groups, or the like or mixtures or combinations thereof. Exemplary examples of salts of nitrogen bases, include, without limitation, salts of nitrogen bases derived from a salt, e.g.: C₁ to C₈ monocarboxylic acids such as formic acid, acetic acid, propanoic acid, butanoic acid, pentanoic acid, hexanoic acid, heptanoic acid, octanoic acid, 2-ethylhexanoic acid, or the like; C₂ to C₁₂ dicarboxylic acids, C₂ to C₁₂ unsaturated carboxylic acids and anhydrides, or the like; polyacids such as diglycolic acid, aspartic acid, citric acid, or the like; hydroxy acids such as lactic acid, itaconic acid, or the like; aryl and hydroxy aryl acids; naturally or synthetic amino acids; thioacids such as thioglycolic acid (TGA); free acid forms of phosphoric acid derivatives of glycol, ethoxylates, ethoxylated amine, or the like, and aminosulfonic acids; or mixtures or combinations thereof and an amine, e.g.: high molecular weight fatty acid amines such as cocoamine, tallow amines, or the like; oxyalkylated fatty acid amines; high molecular weight fatty acid polyamines (di, tri, tetra, or higher); oxyalkylated fatty acid polyamines; amino amides such as reaction products of carboxylic acid with polyamines where the equivalents of carboxylic acid is less than the equivalents of reactive amines and oxyalkylated derivatives thereof; fatty acid pyrimidines; monoimidazolines of EDA, DETA or higher ethylene amines, hexamethylene diamine (HMDA), tetramethylenediamine (TMDA), and higher analogs thereof; bisimidazolines, imidazolines of mono and polyorganic acids; oxazolines derived from monoethanol amine and fatty acids or oils, fatty acid ether amines, mono and bis amides of aminoethylpiperazine; GAA and TGA salts of the reaction products of crude tall oil or distilled tall oil with diethylene triamine; GAA and TGA salts of reaction products of dimer acids with mixtures of poly amines such as TMDA, HMDA and 1,2-diaminocyclohexane; TGA salt of imidazoline derived from DETA with tall oil fatty acids or soy bean oil, canola oil, or the like; or mixtures or combinations thereof.

Other Additives

The drilling fluids of this invention can also include other additives as well such as scale inhibitors, carbon dioxide control additives, paraffin control additives, oxygen control additives, or other additives.

Scale Control

Suitable additives for Scale Control and useful in the compositions of this invention include, without limitation: Chelating agents, e.g., Na⁺, K⁻ or NH₄⁺ salts of EDTA; Na⁺, K⁺ or NH₄⁺ salts of NTA; Na⁺, K⁺ or NH₄⁺ salts of Erythorbic acid; Na⁺, K⁺ or NH₄⁺ salts of thioglycolic acid (TGA); Na⁺, K⁺ or NH₄⁺ salts of Hydroxy acetic acid; Na⁺, K⁺ or NH₄⁻ salts of Citric acid; Na, K or NH₄⁻ salts of Tartaric acid or other similar salts or mixtures or combinations thereof. Suitable additives that work on threshold effects, sequestrants, include, without limitation: Phosphates, e.g., sodium hexamethylphosphate, linear phosphate salts, salts of polyphosphoric acid, Phosphonates, e.g., nonionic such as HEDP (hydroxythylidene diphosphoric acid), PBTC (phosphoisobutane, tricarboxylic acid), Amino phosphonates of: MEA (monoethanolamine), NH₃, EDA (ethylene diamine), Bishydroxyethylene diamine, Bisaminoethylether, DETA (diethylenetriamine), HMDA (hexamethylene diamine), Hyper homologues and isomers of HMDA, Polyamines of EDA and DETA, Diglycolamine and homologues, or similar polyamines or mixtures or combinations thereof; Phosphate esters, e.g., polyphosphoric acid esters or phosphorus pentoxide (P₂O₅) esters of: alkanol amines such as MEA, DEA, triethanol amine (TEA), Bishydroxyethylethylene diamine; ethoxylated alcohols, glycerin, glycols such as EG (ethylene glycol), propylene glycol, butylene glycol, hexylene glycol, trimethylol propane, pentaeryithrol, neopentyl glycol or the like; Tris & Tetra hydroxy amines; ethoxylated alkyl phenols (limited use due to toxicity problems), Ethoxylated amines such as monoamines such as MDEA and higher amines from 2 to 24 carbons atoms, diamines 2 to 24 carbons carbon atoms, or the like; Polymers, e.g., homopolymers of aspartic acid, soluble homopolymers of acrylic acid, copolymers of acrylic acid and methacrylic acid, terpolymers of acylates, AMPS, etc., hydrolyzed polyacrylamides, poly malic anhydride (PMA); or the like; or mixtures or combinations thereof.

Carbon Dioxide Neutralization

Suitable additives for CO₂ neutralization and for use in the compositions of this invention include, without limitation, MEA, DEA, isopropylamine, cyclohexylamine, morpholine, diamines, dimethylaminopropylamine (DMAPA), ethylene diamine, methoxy proplyamine (MOPA), dimethylethanol amine, methyldiethanolamine (MDEA) & oligomers, imidazolines of EDA and homologues and higher adducts, imidazolines of aminoethylethanolamine (AEEA), aminoethylpiperazine, aminoethylethanol amine, di-isopropanol amine, DOW AMP-90™, Angus AMP-95, dialkylamines (of methyl, ethyl, isopropyl), mono alkylamines (methyl, ethyl, isopropyl), trialkyl amines (methyl, ethyl, isopropyl), bishydroxyethylethylene diamine (THEED), or the like or mixtures or combinations thereof.

Paraffin Control

Suitable additives for Paraffin Removal, Dispersion, and/or paraffin Crystal Distribution include, without limitation: Cellosolves available from DOW Chemicals Company; Cellosolve acetates; Ketones; Acetate and Formate salts and esters; surfactants composed of ethoxylated or propoxylated alcohols, alkyl phenols, and/or amines; methylesters such as coconate, laurate, soyate or other naturally occurring methylesters of fatty acids; sulfonated methylesters such as sulfonated coconate, sulfonated laurate, sulfonated soyate or other sulfonated naturally occurring methylesters of fatty acids; low molecular weight quaternary ammonium chlorides of coconut oils, soy oils or C₁₀ to C₂₄ amines or monohalogenated alkyl and aryl chlorides; quanternary ammonium salts composed of disubstituted (e.g., dicoco, etc.) and lower molecular weight halogenated alkyl and/or aryl chlorides; gemini quaternary salts of dialkyl (methyl, ethyl, propyl, mixed, etc.) tertiary amines and dihalogenated ethanes, propanes, etc. or dihalogenated ethers such as dichloroethyl ether (DCEE), or the like; gemini quaternary salts of alkyl amines or amidopropyl amines, such as cocoamidopropyldimethyl, bis quaternary ammonium salts of DCEE; or mixtures or combinations thereof. Suitable alcohols used in preparation of the surfactants include, without limitation, linear or branched alcohols, specially mixtures of alcohols reacted with ethylene oxide, propylene oxide or higher alkyleneoxide, where the resulting surfactants have a range of HLBs. Suitable alkylphenols used in preparation of the surfactants include, without limitation, nonylphenol, decylphenol, dodecylphenol or other alkylphenols where the alkyl group has between about 4 and about 30 carbon atoms. Suitable amines used in preparation of the surfactants include, without limitation, ethylene diamine (EDA), diethylenetriamine (DETA), or other polyamines. Exemplary examples include Quadrols, Tetrols, Pentrols available from BASF. Suitable alkanolamines include, without limitation, monoethanolamine (MEA), diethanolamine (DEA), reactions products of MEA and/or DEA with coconut oils and acids.

Oxygen Control

The introduction of water downhole often is accompanied by an increase in the oxygen content of downhole fluids due to oxygen dissolved in the introduced water. Thus, the materials introduced downhole must work in oxygen environments or must work sufficiently well until the oxygen content has been depleted by natural reactions. For a system that cannot tolerate oxygen, oxygen must be removed or controlled in any material introduced downhole. The problem is exacerbated during the winter when the injected materials include winterizers such as water, alcohols, glycols, Cellosolves, formates, acetates, or the like and because oxygen solubility is higher to a range of about 14-15 ppm in very cold water. Oxygen can also increase corrosion and scaling. In CCT (capillary coiled tubing) applications using dilute solutions, the injected solutions result in injecting an oxidizing environment (O₂) into a reducing environment (CO₂, H₂S, organic acids, etc.).

Options for controlling oxygen content includes: (1) de-aeration of the fluid prior to downhole injection, (2) addition of normal sulfides to produce sulfur oxides, but such sulfur oxides can accelerate acid attack on metal surfaces, (3) addition of erythorbates, ascorbates, diethylhydroxyamine or other oxygen reactive compounds that are added to the fluid prior to downhole injection; and (4) addition of corrosion inhibitors or metal passivation agents such as potassium (alkali) salts of esters of glycols, polyhydric alcohol ethyloxylates or other similar corrosion inhibitors. Oxygen and corrosion inhibiting agents include mixtures of tetramethylene diamines, hexamethylene diamines, 1,2-diaminecyclohexane, amine heads, or reaction products of such amines with partial molar equivalents of aldehydes. Other oxygen control agents include salicylic and benzoic amides of polyamines, used especially in alkaline conditions, short chain acetylene diols or similar compounds, phosphate esters, borate glycerols, urea and thiourea salts of bisoxalidines or other compound that either absorb oxygen, react with oxygen or otherwise reduce or eliminate oxygen.

Salt Inhibitors

Suitable salt inhibitors for use in the fluids of this invention include, without limitation, Na Minus Nitrilotriacetamide available from Clearwater International, LLC of Houston, Tex.

### Mixing and Comminuting Processes

The particulate weighted elastomer systems of this invention may be prepared by taking solid weighted elastomers of this invention and comminuting the solid weighted elastomers of this invention into particulate weighted elastomer systems of this invention of a desired particle size or particle size distribution. The solid weighted elastomers of this invention may be prepared by dry mixing in internal mixers such as internal mixers (e.g., Bandury mixers, etc.), extruders, co-extruders, or any other type of internal mixers that utilize shearing to heat and mix dry elastomers and fillers such as weighting agents together. The particulate weighted elastomer systems of this invention may also be prepared by wet mixing techniques followed by solvent removal and comminuting the solid weighted elastomers into particulate solid weighting elastomer systems of this invention. The solvents may be water, aqueous solutions, organic solvents, organic solvent systems, or any other component that may be used to facilitate combining the elastomers and the weighting agents and then are removed to produce the weighted elastomer systems of this invention. Once solid weighted elastomers of this invention are prepared, the solids may be comminuted by any particle size reduction methods known or will be invented in the future. Exemplary examples of suitable comminuting processes or particle size reduction processes for use in the practice of this invention include, without limitation, cryogenic grinding, cryogenic shredding, cryogenic pulverizing, cryogenic fracturing, conventional grinding, shredding, pulverizing, any other comminuting process, and mixtures or combinations thereof.

### COMPOSITIONS AND RANGES OF COMPONENTS

### Cement or Cementing Compositions

The high density cement compositions of this invention are slurries generally including water, an optional gelling system, and hydraulic cement system, where the hydraulic cement system includes a weighted elastomer subsystem including at least one weighting agent and at least one elastomer.

The fluid compositions of this invention including an effective amount of weighting elastomer systems are particularly well suited as drilling fluids and drilling muds including elastomers that tend to float or separate due to their low specific gravities. In certain embodiments, the compositions may also include fluid loss control additives such as bentonite, cellulose derivatives, polyacrylamides, polyacrylates or the like, while also possessing utility as blow-out control fluids. In other embodiments, the compositions of this invention are particularly well suited as high density kill fluids, where environmental compatibility is of concern.

In other embodiments, the viscosity of the compositions of this invention may be controlled using commercially available viscosifiers and dispersants, with such addition occurring either before addition of the optional gelling agent if present or simply added to the fluid when a powdered material is being incorporated. The variety and amount of the dispersants, viscosifiers, gelling agent and weighted elastomer system used will be dictated by the well parameters.

Dispersants and viscosifiers may be added to provide additional rheology control and an example of a common dispersant chemistry is naphthalene sulfonates dispersant. An example of an acceptable viscosifier is hydroxethyl cellulose, Viscosifier. Generally, a dispersant may be added to reduce friction so that the turbulent flow can be achieved at lower pumping rates, as well as to reduce fluid loss. In general, it is easier to over disperse the fluid in question with the dispersant and thereafter use a small amount of viscosifier to elevate the viscosity to a desired level.

In certain embodiments, it has been found that particulate weighted elastomer systems form more stable suspensions or slurries for use as drilling fluids, drilling muds, and blow-out control fluids.

In utilizing the cementing compositions of this invention including a weighted elastomer composition of this invention for sealing a subterranean formation, a specific quantity of cement slurry is prepared and introduced through the well bore into the formation to be treated. The cement slurry is particularly useful in cementing the annular void space (annulus) between a casing or pipe in the borehole. The cement slurry is easily pumped downwardly through the pipe and then outward and upwardly into the annular space on the outside of the pipe. Upon solidifying, the cement slurry sets into a high strength, high density, concrete forms or structures having improved resiliency, swellability, and self-healing nature of the cement matrix.

When the cement slurry is utilized in a high temperature environment, such as deep oil wells, set time retarders may be utilized in the cement composition in order to provide ample fluid time for placement of the composition at the point of application.

A particularly desirable use of a weighted elastomer system of this invention in cement compositions is in oil field applications, where borehole conditions of a well limit the interval in which high density cement may be used for the purpose of controlling a pressurized formation. An example of such a use would be when a weak formation is separated from an over-pressured formation by relatively short intervals.

Embodiments of the cement fluids of this invention include a weighted elastomer system of this invention present in the cement slurry in an amount between about 0.5% by weight of cement (bwoc) and about 50% bwoc. In certain embodiments, the weighted elastomer systems are present in the cement slurry in an amount between about 1.0% by weight of cement (bwoc) and about 50% bwoc. In other embodiments, the weighted elastomer systems are present in the cement slurry in an amount between about 5.0% by weight of cement (bwoc) and about 50% bwoc. In certain embodiments, the weighted elastomer systems are present in the cement slurry in an amount between about 10.0% by weight of cement (bwoc) and about 50% bwoc.

Embodiments of hydraulic cement compositions of this invention may also include a retarder in the amount of 0.1-3% (dry weight) based on the weight of cement. The chemical composition of retarders are known in the art. They may be based on lignosulfonates, modified lignosulfonates, polyhydroxy carboxylic acids, carbohydrates, cellulose derivatives or borates. Some of the retarders will also act as dispersants in the hydraulic cement slurry and when such retarders are used the dosage of dispersants may be reduced.

Embodiments of hydraulic cement compositions of this invention may also include a thinner or dispersant in an amount of 0.7 to 6% (dry weight) based on the weight of the cement. Dispersant additives which are known as plasticizers or super-plasticizers in cement based systems can be used. These are well-known additives which may be based on lignosulfonate, sulfonated napthaleneformaldehyde or sulfonated melamineformaldehyde products.

Embodiments of hydraulic cement compositions of this invention may also include 0.1-4% (dry weight) of a fluid loss additive based on the weight of the cement. Known fluid loss additives may be based on starch or derivates of starch, derivates of cellulose such as carboxymethylcellulose, methylcellulose or ethylcellulose or synthetic polymers such as polyacrylonitrile or polyacrylamide may be used.

Cement slurries which are used at high well temperature may also include 10-35% silica flour and/or silica sand based on the weight of the cement.

Both fresh water and sea water may be used in the hydraulic cement slurry of the present invention.

If necessary, accelerators may be incorporated into the cement slurry in order to adjust the setting time.

It has surprisingly been found that the high density hydraulic cement compositions of the present invention are gas tight, show very little tendency of settling and have low strength retrogression. Thus the content of high density filler material and the content of silica sand or silica flour may be increased above the conventional levels without affecting the plasticity of the cement slurries while the tendency of settling is strongly reduced.

In certain embodiments, the high density cement compositions of this invention have a density of about 21 lbs/gallon.

In certain embodiments, the high density cement compositions of this invention may include a second weighting material in addition to the primary weighting material comprising a metal silicon alloy or mixtures of metal silicon alloys, where the second weighting material including iron, steel, barite, hematite, other iron ores, tungsten, tin, manganese, manganese tetraoxide, calcium carbonate, illmenite, sand or mixtures thereof. The relative amount and type of the two weighting materials may be selected to produce desired properties of the cementing composition.

### Methods of Cementing

The overall process of cementing an annular space in a wellbore typically includes the displacement of drilling fluid with a spacer fluid or preflushing medium which will further assure the displacement or removal of the drilling fluid and enhance the bonding of the cement to adjacent structures. For example, it is contemplated that drilling fluid may be displaced from a wellbore, by first pumping into the wellbore a spacer fluid according to the present invention for displacing the drilling fluid which in turn is displaced by a cement composition or by a drilling fluid which has been converted to cement, for instance, in accordance with the methods disclosed in U.S. Pat. No. 4,883,125, the entire disclosure is incorporated by reference due to the action of the last paragraph of the specification.

In other embodiments, the spacer compositions of this invention (1) provide a buffer zone between the drilling fluid being displaced and the conventional cement slurry following the spacer fluid, (2) enhance the bonding between the conventional cement slurry and the surfaces of the borehole and casing, and (3) set to provide casing support and corrosion protection.

In other embodiments of the present invention, the spacer fluid may comprise, in combination, water, styrene-maleic anhydride copolymers (SMA) as a dispersant with or without anionic and/or nonionic water wetting surfactants, and with or without viscosifying materials such as HEC (hydroxyethyl cellulose), CMHEC (carboxymethylhydroxyethyl cellulose), PHPA (partially hydrolyzed polyacrylamide), bentonite, attapulgite, sepiolite and sodium silicate and weighted elastomer system including at least one metal silicon alloys to form a rheologically compatible medium for displacing drilling fluid from the wellbore.

In other embodiments a of the present invention, the spacer fluid comprises SMA, bentonite, welan gum, surfactant and a weighting agent. Preferably, the spacer fluid according to the fourth embodiment of the present invention comprises a spacer dry mix which includes: 1) 10 wt. % to 50 wt. % by weight of SMA as a dispersant; 2) 40 wt. % to 90 wt. % by weight of bentonite as a suspending agent; 3) 1 wt. % to 20 wt. % welan gum as a pseudoplastic, high efficiency viscosifier tolerant to salt and calcium, available from Kelco, Inc. under the trade name BIOZANTM; 4) 0.01 gal per bbl to 10.0 gal per bbl of aqueous base spacer of an ethoxylated nonylphenol surfactant having a mole ratio of ethylene oxide to nonylphenol ranging from 1.5 to 15, available from GAF under the trade name IGEPAL; 5) 20 wt. % to 110 wt. % of a weighted elastomer system including at least one metal silicon alloy having a density greater than or equal to about 6.0 g/cm³. In certain embodiments, the weighting agent will be added to the spacer fluid in an amount to give the spacer fluid a density equal to or greater than the density of the drilling fluid and less than or equal to the density of the cement slurry.

In well cementing operations such as primary cementing, a cement slurry is pumped into the annulus between a string of casing disposed in the well bore and the walls of the well bore for the intended purpose of sealing the annulus to the flow of fluids through the well bore, supporting the casing and protecting the casing from corrosive elements in the well bore. The drilling fluid present in the annulus partially dehydrates and gels as it loses the filtrate to the formation. The presence of this partially dehydrated/gelled drilling fluid in the annulus is detrimental to obtaining an adequate cement bond between the casing and the well bore. As the casing becomes more eccentric, the removal process becomes more difficult.

In order to separate the cement slurry from the drilling fluid and remove partially dehydrated/gelled drilling fluid from the walls of the well bore ahead of the cement slurry as it is pumped, a spacer fluid is inserted between the drilling fluid and the cement slurry. The spacer fluid prevents contact between the cement slurry and drilling fluid and it is intended to possess rheological properties which bring about the removal of partially dehydrated/gelled drilling fluid from the well bore. However, virtually all elements of the downhole environment work against this end. Fluid loss from the drilling fluid produces localized pockets of high viscosity fluid. At any given shear rate (short of turbulent flow) the less viscous spacer fluid will tend to channel or finger through the more viscous drilling fluid. At low shear rates, the apparent viscosity of most cement and spacer fluids is lower than that of the high viscosity drilling fluid in localized pockets. To overcome this, the cement and spacer fluids are pumped at higher rates so that the fluids are at higher shear rates and generally have greater apparent viscosities than the drilling fluid. Drag forces produced by the drilling fluid upon filter cake are also increased. Unfortunately, the pump rates that are practical or available are not always sufficient to effectively displace and remove drilling fluid from the well bore prior to primary cementing.

Displacement of the drilling fluid is hindered by the fact that the pipe is generally poorly centered causing an eccentric annulus. In an eccentric annulus, the displacing spacer fluid tends to take the path of least resistance. It travels or channels through the wide side of the eccentric annulus where the overall shear level is lower. Since the cement and spacer fluid travel faster up the wide side of the annulus, complete cement coverage may not result before completion of the pumping of a fixed volume. Also, since the flow path will generally spiral around the pipe, drilling fluid pockets are often formed.

The displacement of drilling fluid from well bore washouts is also a problem. When the velocity (shear rate) and relative shear stress of the cement and spacer fluid are lowered due to encountering an enlarged well bore section, it is difficult for the spacer fluid to displace the drilling fluid. The cross-sectional area in enlarged sections of a well bore can be several orders of magnitude greater than the predominate or designed annulus. Fluid flow through those sections is at much lower shear rates and generally the annulus is also more eccentric since the well bore diameter is often outside the maximum effective range of casing centralizers.

Another problem which adversely affects drilling fluid displacement is spacer fluid thermal thinning A high degree of thermal thinning normally limits available down hole viscosity, particularly at elevated temperatures and low shear rates. In that situation, adequate viscosity at the lower shear rates can often not be obtained because the spacer fluid at the surface would be too viscous to be mixed or pumped. Even a very viscous spacer fluid exhibits relatively little viscosity at low shear rates and elevated temperatures.

Typically, one or more of the above mentioned rheological or other factors are working against efficient drilling fluid displacement. As a result, pockets of non-displaced drilling fluid are generally left within the annulus at the end of displacement. As mentioned, high displacement rates would help many of these problems, but in most field applications pump capacity and formation fracture gradients limit the displacement rates to less than those required. Even when relatively high pump rates can be utilized, cement evaluation logs typically show a good cement sheath only in areas of good centralization and normal well bore diameter.

Another problem involves the lack of solids suspension by spacer fluids. The thermal thinning and reduced low shear rate viscosity exhibited by many spacer fluids promotes sedimentation of solids. Until a spacer fluid develops enough static gel strength to support solids, control of sedimentation is primarily a function of low shear rate viscosity. In deviated or horizontal well bores, solids support is much more difficult and at the same time more critical. The more nearly horizontal the well bore is the shorter the distance for coalescence. As a result, high density solids can quickly build-up on the bottom of the well bore.

An ideal spacer fluid would have a flat rheology, i.e., a 300/3 ratio approaching 1. It would exhibit the same resistance to flow across a broad range of shear rates and limit thermal thinning, particularly at low shear rates. A 300/3 ratio is defined as the 300 rpm shear stress divided by the 3 rpm shear stress measured on a Chandler or Fann Model 35 rotational viscometer using a B1 bob, an R1 sleeve and a No. 1 spring. The greater the resultant slope value, the more prone the spacer fluid is to channeling in an eccentric annulus; 300/3 ratios of 2 to 6 are achieved by the spacer fluid compositions of this invention. As a result, the compositions are better suited for drilling fluid displacement than prior art spacer fluids. The spacer fluids of this invention have relatively flat rheologies and are not impacted by eccentric annuli since they exhibit nearly the same resistance to flow across the whole annulus. Most prior art spacers exhibit a 300/3 ratio of 8-10.

By the present invention, improved spacer fluids are provided which have excellent compatibility with treating fluids such as cement slurries, drilling fluids and other completion fluids. The spacer fluids also possess the ability to suspend and transport solid materials such as partially dehydrated/gelled drilling fluid and filter cake solids from the well bore. Further, the relatively flat rheology spacer fluids of this invention possess the ability to maintain nearly uniform fluid velocity profiles across the well bore annulus as the spacer fluids are pumped through the annulus, i.e., the spacer fluids are pseudo-plastic with a near constant shear stress profile.

A dry mix composition of this invention for forming an aqueous, high density spacer fluid comprises a hydrous magnesium silicate clay, silica, an organic polymer and a weighted elastomer system including at least one metal silicon alloy having a density of at least 6.0. The hydrous magnesium silicate clay may include sepiolite and/or attapulgite.

Various forms of silica may be used such as fumed silica and colloidal silica. Fumed silica is preferred for use in the dry mix composition of this invention. As will be described further, colloidal silica is preferably used in the spacer compositions which are prepared by directly mixing the individual components with water.

The organic polymer may be welan gum, xanthan gum, galactomannan gums, succinoglycan gums, scleroglucan gums, cellulose and its derivatives, e.g., HEC, or mixtures and combinations thereof.

The dry mix compositions and/or the aqueous spacer fluids may also include a dispersing agent, a surfactant, and a weighting material. The dispersant improves compatibility of fluids which would otherwise be incompatible. The surfactant improves bonding and both the dispersant and surfactant aid in the removal of partially dehydrated/gelled drilling fluid. The weighting material increases the density of the spacer fluid.

Various dispersing agents can be utilized in the compositions of this invention. However, preferred dispersing agents are those selected from the group consisting of sulfonated styrene maleic anhydride copolymer, sulfonated vinyl-toluene maleic anhydride copolymer, sodium naphthalene sulfonate condensed with formaldehyde, sulfonated acetone condensed with formaldehyde, ligno-sulfonates and interpolymers of acrylic acid, allyloxybenzene sulfonate, allyl sulfonate and non-ionic monomers. Generally, the dispersing agent is included in the dry mix composition in an amount in the range of from about 0.5% to about 50% by weight of the composition. It is included in the aqueous spacer fluid in an amount in the range of from about 0.05% to about 3% by weight of water in the aqueous spacer fluid composition (from about 0.1 pounds to about 10 pounds per barrel of spacer fluid). The dispersant can be added directly to the water if in liquid or solid form or included in the dry mix composition if in solid form.

While various water-wetting surfactants can be used in the compositions, nonylphenol ethoxylates, alcohol ethoxylates and sugar lipids are generally preferred. When used, the surfactant is included in the spacer fluid in an amount which replaces up to about 20% of the water used, i.e., an amount in the range of from about 0.1 gallon to about 10 gallons per barrel of spacer fluid when the surfactant is in the form of a 50% by weight aqueous concentrate. The surfactant is normally added directly to the water used or to the aqueous spacer fluid.

Other components can advantageously be included in the spacer fluids of this invention in relatively small quantities such as salts, e.g., ammonium chloride, sodium chloride and potassium chloride.

As mentioned, the spacer fluids of this invention are pseudo-plastic fluids with near constant shear stress profiles, i.e., 300/3 ratios of from about 2 to about 6. This property of the spacer fluids of this invention is particularly important when the spacer fluids are utilized in primary cementing operations. The property allows the spacer fluids to maintain nearly uniform fluid velocity profiles across a well bore annulus as the spacer fluids followed by cement slurries are pumped into the annulus. The nearly uniform fluid velocity profile brings about a more even distribution of hydraulic force impinging on the walls of the well bore thereby enhancing the removal of partially dehydrated/gelled drilling fluid and solids from the well bore. This property of the spacer fluid is particularly important in applications where the casing being cemented is located eccentrically in the well bore (an extremely probable condition for highly deviated well bores).

In carrying out the methods of the present invention, a first fluid is displaced with an incompatible second fluid in a well bore utilizing a spacer fluid of the invention to separate the first fluid from the second fluid and to remove the first fluid from the well bore. In primary cementing applications, the spacer fluid is generally introduced into the casing or other pipe to be cemented between drilling fluid in the casing and a cement slurry. The cement slurry is pumped down the casing whereby the spacer fluid ahead of the cement slurry displaces drilling fluid from the interior of the casing and from the annulus between the exterior of the casing and the walls of the well bore. The spacer fluid prevents the cement slurry from contacting the drilling fluid and thereby prevents severe viscosification or flocculation which can completely plug the casing or the annulus. As the spacer fluid is pumped through the annulus, it aggressively removes partially dehydrated/gelled drilling fluid and filter cake solids from the well bore and maintains the removed materials in suspension whereby they are removed from the annulus. As mentioned above, in primary cementing applications, the spacer fluid preferably includes a surfactant whereby the surfaces within the annulus are water-wetted and the cement achieves a good bond to the surfaces.

The cement composition of this invention may also include hydraulic binders and reinforcing particles. The flexible particles include materials having a Young's modulus of less than 5000 mega Pascals (Mpa). In certain embodiments, the flexible particles have a Young's modulus of less than 3000 Mpa, while in other embodiments, the flexible particles have a Young's modulus of less than 2000 Mpa. In certain embodiments, the elasticity of these particles is at least four times greater than that of cement and more than thirteen times that of the silica usually used as an additive in oil well cements. In certain embodiments, the flexible particles are added to the cementing compositions of the invention have low compressibility. In certain embodiments, the materials are more compressible than rubbers, in particular with a Poisson ratio of less than 0.45. In other embodiments, the Poisson ratio is less than 0.4. However, materials which are too compressible, with a Poisson ratio of less than 0.3 may result in inferior behavior.

The reinforcing particles are generally insoluble in an aqueous medium which may be saline, and they must be capable of resisting a hot basic medium since the pH of a cementing slurry is generally close to 13 and the temperature in a well is routinely higher than 100° C.

In certain embodiments, the flexible particles are isotropic in shape. Spherical or near spherical particles may be synthesized directly, but usually the particles are obtained by grinding such as by cryo-grinding. The average particle size ranges from about 80 μm to about 1000 In other embodiments, the average particle size ranges from about 100 μm to about 500 Particles which are too fine, also particles which are too coarse, are difficult to incorporate into the mixture or result in pasty slurries which are unsuitable for use in an oil well.

Particular examples of materials which satisfy the various criteria cited above are thermoplastics (polyamide, polypropylene, polyethylene, . . . ) or other polymers such as styrene divinylbenzene or styrene butadiene (SBR).

In addition to flexible particles and weighting agents of this invention, the cementing compositions of the invention comprise an hydraulic binder, in general based on Portland cement and water. Depending on the specifications regarding the conditions for use, the cementing compositions can also be optimized by adding additives which are common to the majority of cementing compositions, such as suspension agents, dispersing agents, anti-foaming agents, expansion agents (for example magnesium oxide or a mixture of magnesium and calcium oxides), fine particles, fluid loss control agents, gas migration control agents, retarders or setting accelerators.

A typical composition of the invention comprise, by volume, 2% to 15% of a weighting composition of this invention, 5% to 20% of flexible particles, 20% to 45% of cement and 40% to 50% of mixing water.

The formulations of the invention may be based on Portland cements including classes A, B, C, G, H and/or R as defined in Section 10 of the American Petroleum Institute's (API) standards. In certain embodiments, the Portland cements includes classes G and/or H, but other cements which are known in this art can also be used to advantage. For low-temperature applications, aluminous cements and Portland/plaster mixtures (for deepwater wells, for example) or cement/silica mixtures (for wells where the temperature exceeds 120° C., for example) may be used, or cements obtained by mixing a Portland cement, slurry cements and/or fly ash.

The water used to constitute the slurry is preferably water with a low mineral content such as tap water. Other types of water, such as seawater, can possibly be used but this is generally not preferable.

These particles with low density with respect to the cement can affect the flexibility of the system, since adding flexible particles produces cements with a lower Young's modulus, while producing low permeability and better impact resistance.

The mechanical properties of the compositions comprising flexible particles of the invention are remarkable, rendering them particularly suitable for cementing in areas of an oil well which are subjected to extreme stresses, such as perforation zones, junctions for branches of a lateral well or plug formation.

### EXPERIMENTS OF THE INVENTION

### EXAMPLE 1

Weighted Elastomer Blend Preparation

The following example illustrate the preparation of a ground weighted elastomer system of used in cement, where the weighting material is ferro silicon and the elastomer is a styrene-butadiene rubber (SBR).

400 gm a styrene-butadiene (SBR) elastomer and 560 gm Ferro Silicon powder was blended using a roller. After thorough mixing, the blend was cryogenically ground forming a ground weighted elastomeric composition having a particle size distribution set forth in Table I.

TABLE I
Particle Size Distribution of Ferro
Silicon Weighted Elastomer System

| US Mesh Size | % Retained |
|---|---|
| 14 | 0.00 |
| 16 | 3.20 |
| 20 | 26.20 |
| 30 | 19.80 |
| 40 | 12.30 |
| Pan | 38.50 |
| Total | 100.00 |

### EXAMPLE 2

Cement Slurry Designs

The following example illustrate the preparation and curing of a controlcement (CC) excluding the weighted elastomer composition of Example 1 and an elastomer weighted cement of this invention (EWC).

The cement slurries were prepared by mixing together the ingredients and their relative amounts listed in Table II using API RP 10B-2 mixer.

TABLE II
Component Formula of Cement Compositions CC and EWC

| | | |
|---|---|---|
| Components | CC | EWC |

| | | | | |
|---|---|---|---|---|
| Cement | 100% | bwoc | 100% | bwoc |
| Silica fume | 1% | bwoc | 8% | bwoc |
| Fluid Loss Control | 0.8% | bwoc | 0.8% | bwoc |
| Weighted Elastomer | 0.0% | bwoc | 25% | bwoc |
| Deafoamer | 0.02 | gal/sk | 0.02 | gal/sk |
| Water | 44% | bwoc | 43% | bwoc |
| Density | 15.8 | lb/gal | 15.8 | lb/gal |

Curing of the Cement Slurries

The two slurries were poured into 2×2×2 inch cubes and cured at 150° F. and 3000 psi for 48 hrs.

Compression Testing of the Cements

The cured CC and EWC cement compositions were then subjected to compression testing to determine its compressive strength. Its compressive strength was carried out according to the ASTM C109 procedure using a loading rate of 4000 psi/min according to the API RP-10B2 procedure. The testing showed that the cured CC composition was brittle and shattered under compression testing, while the cured EWC composition was resilient under compression testing. The results of the compression testing are shown pictorially in FIGS. 2&2. Thus, 25% bwoc of the elastomeric composition of Example 1, rendered an equal density cement resilient, where a similar cement (actually including less fumed silica) was brittle under compression.

### CLOSING PARAGRAPH OF THE INVENTION

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

We claim:

1. A cement composition comprising:
water,
a hydraulic cement, and
a weighted elastomer system including:
at least one higher density weighting agent and
at least one elastomer,
where the weighting agent has a density of at least 5.0 g/cm³ and
where the weighted elastomer system increases a density of the composition, while maintaining other properties including at least pumpability, gas tight sealing, low tendency to segregate, and/or reduced high temperature cement strength retrogression.

2. The composition of claim 1, further comprising:
a gelling agent including oxides of antimony, zinc oxide, barium oxide, barium sulfate, barium carbonate, iron oxide, hematite, other irons ores and mixtures thereof,
a dispersant, and/or
a fluid loss control additive.

3. The composition of claim 1, the weighted elastomer system further includes:
a secondary weighting agent.

4. The composition of claim 1, the weighted elastomer system further includes:
a crosslinking agent,
a coupling agent, or
a mixture of a crosslinking agent and a coupling agent.

5. The composition of claim 1, the weighted elastomer system comprises a powder, a shot, or mixtures and combinations thereof.

6. The composition of claim 1, the composition has a relatively low plastic viscosity, a relatively low yield point, a relatively faster cure, a relatively higher cure strength after 6 hours of curing and relatively higher final cure strength relative to a cement composition having a weight equivalent of a hematite weighting agent.

7. A cementitious composition comprising:
a cement,
a weighted elastomer system including:
at least one higher density weighting agent and
at least one elastomer,
water,
where the weighted elastomer system is present in an amount between about 0.5% by weight of the composition to about 50% by weight of the composition and where the higher weighting agent has a density of at least 5.0 g/cm³.

8. The composition of claim 7, wherein a ratio of the weighting agents and the elastomers is between about 9:1 and about 1:9.

9. The composition of claim 7, wherein the weighted elastomer system further includes:
a secondary weighting agent.

10. The composition of claim 7, wherein the weighted elastomer system further includes:
a crosslinking agent,
a coupling agent, or
a mixture of a crosslinking agent and a coupling agent.

11. The composition of claim 1, wherein the weighted elastomer system comprises a powder, a shot, or mixtures and combinations thereof.

12. The composition of claim 1, further comprising:
a gelling agent including oxides of antimony, zinc oxide, barium oxide, barium sulfate, barium carbonate, iron oxide, hematite, other irons ores and mixtures thereof;
a dispersing agent; a gelling agent; and/or
a fluid loss control additive.

13. A method of cementing in an annulus between a well casing and a borehole of this invention comprising the step of:
placing in an annulus a cementitious composition, where the composition comprises:
water,
a hydraulic cement; and
a weighted elastomer system including:
at least one weighting agent and
at least one elastomer,
where the higher density weighting agents have a density of at least 5.0 g/cm³ and where the weighted elastomer system increases the density of the composition, while maintaining other properties including at least pumpability, gas tight sealing, low tendency to segregate, and/or reduced high temperature cement strength retrogression.

14. The method of claim 13, further comprising the step of:
allowing the cement to set in place.

15. The method of claim 13, further comprising the step of:
a gelling agent including oxides of antimony, zinc oxide, barium oxide, barium sulfate, other irons ores or mixtures and combinations thereof,
a dispersing agent; and/or
a fluid loss control additive.

16. The method of claim 13, wherein a ratio of the weighting agents and the elastomers is between about 9:1 and about 1:9.

17. The method of claim 1, the weighted elastomer system further includes:
a secondary weighting agent.

18. The method of claim 1, wherein the weighted elastomer system further includes:
a crosslinking agent,
a coupling agent, or
a mixture of a crosslinking agent and a coupling agent.

19. The method of claim 1, wherein the weighted elastomer system comprises a powder, a shot, or mixtures and combinations thereof.

20. A drilling fluid composition comprising:
a base fluid, and
a weighted elastomer system including at least one higher density weighting agent and at least one elastomer, where the higher density weighting agents have a density of at least 5.0 g/cm³,
where the weighted elastomer system increases the density of the composition while maintaining other properties including at least pumpability, and/or low tendency to segregate.

21. The composition of claim 20, wherein a ratio of the higher density weighting agents and the elastomers is between about 9:1 and about 1:9.

22. The composition of claim 20, wherein the weighted elastomer system further includes a secondary weighting agent.

23. The composition of claim 20, wherein the weighted elastomer system further includes a crosslinking agent, a coupling agent, or a mixture of a crosslinking agent and a coupling agent.

24. The composition of claim 20, wherein the weighted elastomer system comprises a powder, a shot, or mixtures and combinations thereof.

25. A methods for drilling a subterranean well comprising the steps:
circulating a drilling fluid, while drilling a borehole, where the drilling fluid includes a base fluid and an effective amount of a weighted elastomer system including at least one higher density weighting agent and at least one elastomer, where the higher density weighting agents have a density of at least 5.0 g/cm³ in a bore hole, where the amount is effective to increase the column weight of the fluid to a desired pressure and where the drilling fluid has improved properties relative to a drilling fluid having a weight equivalent amount of a hematite weighting agent.

26. A spacer fluid composition comprising:
a base fluid and
an effective amount of a weighted elastomer system including at least one higher density weighting agent and at least one elastomer,
where the higher density weighting agents have a density of at least 5.0 g/cm³, and
where the amount is sufficient to impart a desired high bulk density to the composition.

27. A methods for changing fluids in a subterranean well comprising the steps of:
displacing a first fluid in the well with a spacer fluid, and
displacing the spacer fluid in the well with a second fluid,
where the first fluid and spacer fluid are incapable and the spacer fluid and the second fluid are incompatible and the spacer fluid includes a base fluid and an effective amount of a weighted elastomer system including at least one higher density weighting agent and at least one elastomer, where the higher density weighting agents have a density of at least 5.0 g/cm³.
